(19) United States
(12) Patent Application Publication
(10) Pub. No.: US 2006/0190121 A1
(43) Pub. Date: Aug. 24, 2006

(54) Method for the production of a digital colour catalogue

(76) Inventors: Ingrid Magli-Schmitz, Bottmingen (CH); Harald Klumb, Lorrach (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/534,515

(22) PCT Filed: Nov. 6, 2003
(86) PCT No.: PCT/EP03/12386

§ 371 Date: May 11, 2005

(30) Foreign Application Priority Data
Nov. 15, 2002 (EP) 02405985.9

(51) Int. Cl. G06F 19/00

(52) U.S. Cl. 700/130

(57) ABSTRACT

A method for the production of a digital colour catalogue, which comprises a) drawing up a requirement profile for the desired dyeing, b) selecting a group of dyes that meet the requirement profile that has been drawn up, c) determining within the colour space the colour position of the said dyes for the desired dyeing, d) segmenting the colour space of the dyes within a depth of shade plane into triangular areas according to shade, wherein the corner points of the triangular areas correspond to the colour position of the dyes in question, and the said dyes define a range of shades delimited by the triangular areas, e) dividing the triangular arcas within a depth of shade plane arithmetically into a grid in such a manner that the points of intersection of the grid are distributed evenly over the triangular areas, where the points of intersection of the grid correspond to a colour position and a reflectance curve calculated on the basis of a dye recipe is associated with each of those colour positions, and f) if desired visualising the reflectance curves associated with the colour positions by means of a suitable medium, is suitable for providing a comprehensive catalogue of different shades together with the associated dye recipes.

The present invention relates to a method for the production of a digital colour catalogue, to the digital colour catalogue and to the use of the digital colour catalogue in the production of dyeings or prints.

Colour standards for a fashion colour collection are generally defined only on one textile material, for example cotton, although the defined colour standard is also used on many other fibres, for example wool, silk, polyester, polyamide, polyacryl, etc. or mixtures thereof. For the dyeing or printing of different fibre materials, however, dyes from different dye classes are used, for example reactive dyes for cotton, acid dyes for silk, wool or polyamide and disperse dyes for polyester. The disadvantage of the customary procedure is that it can result in metamerism.

Metamerism is defined as the undesirable characteristic whereby two objects, e.g. dyed. cotton and polyester textile materials, appear to be of the same colour, for example in daylight, but in a different light, for example artificial light, exhibit a colour difference. Such metameric objects have different spectral reflectance curves, the integrals of which add up to identical colour values in one type of light, but in the different case the colour values are different. The reflectance curve of an object represents the ratio of reflected light to incident light across the visible spectral region and enables calorimetric information to be obtained about the physical characteristics of a colour.

The market for textiles calls for specific in-use properties, for example good fastness to light for skiwear or summer clothing or seat covers in the automobile industry, good fastness to chlorine for swimwear, good fastness to perspiration for sportswear and good fastness to washing properties for underwear etc.. In general, however, such specifications are not taken into account when dyeing the standard, with the result that it is possible for metamerism to occur in that instance also, especially when it is necessary to switch to dyes that take account of in-use properties only at a later stage.

In the definition of the standards, too little account is also taken of the colour constancy, which has the result that the colour of an object varies under different sources of illumination, or again results in metamerism if the colour constancy is improved.

Colour standards are generally defined by designers who usually have no technical knowledge of the dyeing industry. This results, in some cases, in the definition of colour standards which cannot be dyed on certain textile fibres, with which the requisite fastness properties cannot be achieved or the recipes for which are not technically optimised. This gives rise to all kinds of problems throughout the textile chain, from the designer of the fashion brand through the supplier chain to the dyeing industry, occasionally resulting in considerable financial losses.

A designer may occasionally use as colour standard a wide variety of objects, for example objects made from leather, plastics, metal, paper, flowers, leaves or wood etc. Frequently he will also select his colour standard from colour catalogues. Colour catalogues contain colour samples on a wide variety of materials, for example pigment-dyed paper or dyeings on textile samples of cotton, polyester or wool. In the production of the dyeings that are used to define the colour standard, no account is taken of the fastness requirements for specific uses. Moreover, the number of colours in the colour catalogues that are available is limited, generally from 500 to 2500 different colours. In defining the colour standard using the mentioned objects or colour samples from catalogues, the dye recipes found have to be optimised technically or in respect of the required fastness properties, which can again result in problems of metamerism or colour constancy.

When producing the colour standard, the mentioned problems could be avoided by an intelligent selection of a dye that takes into account all the requirements relating to fastness properties, dyeing technology, metamerism and colour constancy.

The problem underlying the present invention is accordingly to provide a catalogue of colour samples that meet all the requisite fastness properties, are technically robust, exhibit good colour constancy, can be reproduced easily and without metamerism on any desired textile materials and can be used in the definition of a colour standard.

The thinking behind the present invention is that an ideal colour standard does not have to be a dyeing, but can be represented by a reflectance curve.

The reflectance curve can be produced arithmetically, starting from a recipe that has been optimised technically and in respect of the in-use fastness properties and using the stored data of calibration dyeings to calculate the associated reflectance curve. The reflectance curve, which is thus associated with an application optimised dye recipe, can be visualised by means of a suitable medium, for example a calibrated colour screen, and in that manner can be used as a colour standard. The procedure according to the invention accordingly differs fundamentally from the procedure customarily used in the dyeing industry, according to which the dye recipe is calculated for a predetermined, measured reflectance curve, for example the reflectance curve of a defined colour standard. In that procedure, the dye recipe is matched to the reflectance curve, which can result in the above-mentioned problems.

According to the invention, by first defining the dye recipe in accordance with the requirements of application technology and thereafter calculating the reflectance curve corresponding to the dye recipe, it is possible to avoid the above-mentioned problems.

The present invention accordingly relates to a method for the production of a digital colour catalogue, which comprises
a) drawing up a requirement profile for the desired dyeing,
b) selecting a group of dyes that meet the requirement profile that has been drawn up,
c) determining within the colour space the colour position of the said dyes for the desired dyeing,
d) segmenting the colour space of the dyes within a depth of shade plane into triangular areas according to shade, wherein the corner points of the triangular areas correspond to the colour position of the dyes in question, and the said dyes define a range of shades delimited by the triangular areas,
e) dividing the triangular areas within a depth of shade plane arithmetically into a grid in such a manner that the points of intersection of the grid are distributed evenly over the triangular areas, where the points of intersection of the grid correspond to a colour position and a reflectance curve calculated on the basis of a dye recipe is associated with each of those colour positions, and
f) if desired visualising the reflectance curves associated with the colour positions by means of a suitable medium.

A requirement profile drawn up for the desired dyeing according to Step a) is understood to mean the definition of the properties or criteria that the dyed substrate is intended to fulfil. Such properties or criteria are, for example, application-related properties, such as the in-use fastness properties, for example fastness to light, chlorine, rubbing, wetting, wet rubbing, washing, water, seawater or perspiration. Suitable substrates are, for example, textile fibre materials, paper, plastics or metal. Further criteria in drawing up a requirement profile may also include the dyeing or printing process with which the desired dyeing is to be produced, the costs, for example of the dyes, or the pricing of the product.

In the context of the present invention, the term “dyeing” is not limited to dyeings in the customary sense, but also includes customary printing processes. The terms “dyeing” and “dyed substrate” accordingly include both customary dyeing processes and customary printing processes and the coloured objects or substrates produced by means of such processes, respectively.

According to Step b) in the method according to the invention, a group of dyes is selected that meet the defined requirement profile and cover the colour space as well as possible. A group of dyes is understood to mean, for example, three or more dyes. The selected dyes should also be readily combinable with one another, for example when dyeing cotton they should exhibit similar exhaust behaviour. The number of colours in the colour catalogue according to the invention that can be derived arithmetically is thus dependent interalia upon the location of the selected dyes in the colour space, that is to say the number increases with the size of the colour space covered by the selected dyes. The selection of the dyes is advantageously made by a person skilled in the field of dyeing.

As colour space for the method according to the invention there can be used, for example, the known CIE Lab colour coordinate system, the lightness axis L* being replaced by the depth of shade characteristic FT. The advantage of that procedure Is that colour positions of identical depth of shade or of identical colour strength lie in one plane of the colour space. The individual planes of the colour space are defined by the pairs of values a*, b*, which correspond to the values of the same name in the CIE Lab colour coordinate system. The a*, b* value pairs characterise the hue and the colour saturation, which are known to the person skilled in the art from the field of colour communication or colorimetrics and constitute a measure of the shade. Instead of the term “colour saturation”, the specialist literature also uses the terms “chroma” or “colour brilliance”. In the mentioned FTa*b* colour space, colour positions of different depth of shade or colour strength lie one above the other on different planes. When using a depth of shade characteristic based on reflectance measurements, it has proved advantageous to use an additional weighting of the data based on the colour perception of the eye or the impression of colour produced.

As colour space for the method according to the invention, it is also possible to use, for example, the L*C*h colour system, which is based on the same diagram as the CIE Lab colour coordinate system (L*a*b* system), with polar coordinates being used instead of rectangular coordinates.

A suitable depth of shade characteristic FT is, for example, the standard depth, as described, for example, in P. Rabe and 0. Koch, Melliand Textilberichte 38 (1957) pages 173 to 177. The standard depth can be indicated not only in the known 2/1, 1/1, ⅓, ⅙, 1/12 and 1/25 depths, but also further sub-divided, for example in steps of 1/10 standard depth or smaller. Depth of shade characteristics are known to the person skilled in the art of textile dyeing.

As depth of shade characteristic it is also possible to use values from reflectance measurements, obtainable according to instructions in Textilveredlung (1986), pages 299 to 304.

According to the invention, first the colour positions of the selected dyes must be determined according to Step c), preferably in the FTa*b* colour space, thus defining the colour space for the subsequent Steps. The colour positions of the dyes suitable for the desired dyeing are so selected that they lie on a plane of identical depth of shade, for example on a plane defined by the pairs of values a*, b*. The colour positions are ascertained from calibration data. If the calibration data are not known, these must first be ascertained by measurement using a commercially available calorimetric apparatus, for example a commercially available spectral photometer.

Normally the exhaust behaviour of many dyes in the textile dyeing industry is non-linear and it is therefore possible in only a small number of cases to infer from a known concentration for a specific depth of shade, for example a 1/1 standard depth, the concentration to use for a different depth of shade. In most cases it is necessary to ascertain the concentration to use for different depths of shade, and from that data to produce a characteristic exhaust curve for each selected dye and for the desired material to be dyed. In the case of commercially available dyes, the concentrations to use for different depths of shade on different substrates are usually known.

The depth of shade characteristic FT can be ascertained, for example, from a standard depth colour chart. For that purpose, a standard depth chart or a corresponding concentration curve is produced in a manner known perse for each of the selected dyes, for example for the five dyes indicated in FIG. 1 which follows.

The known depth of shade plane thus establishes the concentration of each dye to use for that depth of shade plane.

The planes of the FTa*b* colour space are segmented into triangular areas according to Step d), the comer points of the triangular areas corresponding to the colour position of the dyes that were selected for the desired dyeing in accordance with the requirement profile. The individual triangular areas of each depth of shade plane do not overlap. Each colour position in the colour space is defined by a single dye recipe, which consists, for example, of one dye when the desired colour position corresponds to the FTa*b* data of a single dye, or the recipe is a mixture of, for example, two dyes when the desired colour position lies on the usually non-straight line connecting two dyes, or the recipe is a mixture of, for example, three dyes where the ratio of those three dyes corresponds to the point of intersection of a regular grid superimposed arithmetically over the triangular areas according to Step e).

The dyes selected for the segmentation may themselves already be mixtures of dyes, for example a mixture of two or three dyes, that is to say, for example, that a comer point of the triangular area already corresponds to the colour position of a dye mixture. In that case also, the colour positions of the mixtures must first be ascertained from calibration data.

Once the dyes for a segmentation have been selected and their calibration data have been ascertained in a manner known perse from reflectance measurements at different concentrations and thus at different depths of shade and have been stored in a computer, the segmentation of the FTa*b* colour space according to d) is complete. Using that stored information, according to Step e) colour positions for the selected dye combination are calculated for a defined depth of shade FT, which colour positions are spaced at regular intervals across the range of shades defined by the a*,b* value pairs, that is to say the depth of shade plane is divided into a grid. Each grid point corresponds to a specific concentration ratio between the selected dyes and thus to a specific dye recipe.

FIG. 1 shows the segmentation of the colour space in a depth of shade plane into three segments, the reference numerals P1 to P5 corresponding to the FTa*b* data of the selected dyes Yellow 1 (P1), Yellow 2 (P2), Red (P3), Blue 1 (P4) and Blue 2 (P5).

FIG. 2 is a further example of the segmentation of the colour space in a depth of shade plane into twelve segments, the reference numerals P1 to P9 corresponding to the FTa*b* data of the selected dyes Yellow 1 (P1), Yellow 2 (P2), Orange 1 (P3), Orange 2 (P4), Red 1 (P5), Red 2 (P6), Blue 1 (P7), Blue 2 (P8) and Blue 3 (P9).

The connecting lines shown in FIGS. 1 and 2 are the result of mixing, in each case, two dyes in specific amounts at a predetermined depth of shade, the end points of the connecting lines corresponding to the colour positions of the selected dyes.

FIG. 3 shows a single segment. It is the triangular area produced by points P2, P3 and P4 in FIG. 1. The connecting lines between points P2, P3 and P4 are the colour positions of each of the two-component mixtures. The grid that has been superimposed over the entire triangular area defines colour positions of mixtures having different concentration ratios. Points P2, P3 and P4 define the colour positions of the respective dyes in concentrations C₂, C₃ and C₄. A mixture having the concentrations X₂×C₂, X₃×C₃ and X₄×C₄ (where X₂+X₃+X₄=1) defines a grid point of the same depth of shade. The grid is produced by interpolating series of mixtures between the single dyes In such a manner that the given spacing of the grid is obtained. For the interpolation, the conversion between KWS values and reflectance values is made using the customary procedure according to Kubelka-Munk, as indicated, for example, in Colour Physics for Industry, Ed. R. McDonald, Society of Dyers and Colourists (1987), Chapter 5, 116 ff. In that procedure, the reflectance spectrum and the concentrations of the dyes are stored for each calculated grid point.

FIG. 4 shows a different segment made up of the dyes P10, P5 and P8. A grid was calculated in the same manner for the triangular area. Points P5 and P8 correspond to points P5 and P8 of FIG. 2.

The spacings between the grid points can be preselected. The smaller the spacings, the more colour positions can be determined within a triangular area. The depth of shade plane defined by a triangular area corresponds, for example, to a trichromy at a depth of shade, the comer points of the triangular area corresponding to the colour positions selected for the trichromy. It Is thus possible to regulate the number of colours per trichromy and thus also the number of colours in the catalogue.

FIG. 5 shows the same segment as FIG. 4, the difference being that the spacing between the grid points is twice as large and thus the number of colour positions determined is reduced to ¼.

FIGS. 1 to 5 show a plane of the FTa*b* colour space. The depth of shade characteristic FT of those planes corresponds, for example, to a ⅔ standard depth. For each colour position in a plane having a specific depth of shade characteristic FT, for example for 1/10, 2/10 or 1/1 standard depth, the reflectance curve and the amounts of dye required to dye a specific substrate in that depth of shade are known. The dye concentration depends, for example, on the dye itself, the depth of shade sought, the application procedure and the substrate to be dyed or printed.

The colour positions corresponding to the points of intersection of the grid are in each case associated with a reflectance curve. Behind each reflectance curve lies a specific dye recipe, that is to say instructions for the dyer as to the ratio in which the dyes that are to be combined with one another are to be mixed in order to obtain a dyeing that corresponds to the reflectance spectrum ascertained and that meets the requirement profile defined in advance according to a).

The catalogue which meets the requirement profile defined in advance according to a) is made up of all the reflectance spectra calculated for all the segments in the given depths of shade.

The reflectance spectra ascertained do not, of course, give the observer any impression of colour. According to the invention, that requires the optional Step f), that is to say the implementation of an operation by means of which the reflectance curve is first brought into a format that enables the corresponding colour to be rendered visible using a suitable apparatus. Suitable apparatuses for visualising the reflectance curves are, for example, a colour-calibrated screen, such as a cathode ray tube apparatus or a liquid crystal flat screen, a colour-calibrated projection apparatus or a colour-calibrated inkjet printer. It is preferred to use a colour-calibrated screen. For that purpose, the calculated reflectance spectra are formatted in such a manner that they can be imported into a commercially available colour communication system, for example Colorite ImageMaster by Datacolor or Color Talk by GretagMacbeth. In such a system, for example ImageMaster, the spectra can be shown as real colours.

In the manner according to the invention, for any dyeing problem it is possible to obtain a comprehensive catalogue of different shades which the user can consult. All that is required is the calibration data of the selected dyes.

The user, for example a colour designer, can then look for colours in the catalogue that come closest to his colour original, which may be an idea of a colour, and that meet the previously defined requirements, and obtains the associated reflectance curves which correspond to specific dye recipes. The recipes obtained are used for dyeing. In the event of there being slight differences relative to the colour original, the desired colour can be found easily by the person skilled in the art of dyeing by suitable adaptation of the dye recipe.

For Steps c), d), e) and 0 of the method according to the invention, a computer is advantageously used. Preferably the computer is also used to store and manage the data obtained.

To make it easy to locate the stored reflectance curves in a data bank, they can be provided with a title that contains the dyes used, the substrate and process data and a serial code number. On the basis of that information, the dye recipe associated with the reflectance curves can be recalculated or stored in a recipe data bank.

The method according to the invention is not limited to specific dyes or specific substrates. Dyes of a wide variety of dye classes can be used, irrespective of whether they are water-soluble or disperse dyes. Preference is given to disperse dyes, acid dyes, metal complex dyes, reactive dyes, vat dyes, sulfur dyes, direct dyes and pigments, and also to cationic dyes. Also suitable are natural dyes, developing dyes, such as naphthol dyes, and food dyes.

As an example of the different dye classes, reference may be made to the Colour Index; Colour Index, Third Edition, 1970/1971: Acid Dyes, Volume 1, pages 1001 to 1562; Basic Dyes, Volume 1, pages 1607 to 1688; Direct Dyes, Volume 2, pages 2005 to 2478; Disperse Dyes, Volume 2, pages 2479 to 2743; Food Dyes, Volume 2, pages 2773 to 2788; Leather Dyes, Volume 2, pages 2799 to 2835; Natural Dyes, Volume 3, pages 3225 to 3256; Pigments, Volume 3, pages 3267 to 3390; Reactive Dyes, Volume 3, pages 3391 to 3560; Solvent Dyes, Volume 3, pages 3563 to 3648; Vat Dyes, Volume 3, pages 3719 to 3844.

The method according to the invention is suitable for any desired substrate, that is to say according to the invention the digital colour catalogue can be produced for dyeings on any desired substrates and, accordingly, the catalogue produced by the method according to the invention can be used for dyeing any desired substrates.

The present invention accordingly relates also to the digital colour catalogue obtained by the method according to the invention.

The desired dyeing according to a) is thus preferably a dyeing on leather or on textile fibre materials, for example silk, wool, polyamide fibres, polyurethane fibres, cellulosic fibre materials, such as coffon, linen and hemp, and viscose and cellulose, polyester fibres, polyacrylic fibres and mixtures of the fibre materials mentioned, for example mixtures of cotton and polyester fibres or polyamide fibres. Also suitable as substrates are paper, films and metals, for example polymer-coated aluminium. Preference is given to leather and to textile fibre materials, especially to textile fibre materials.

The present invention relates also to the use of the digital colour catalogue in the production of a dyeing, preferably on leather or on a textile fibre material, especially on a textile fibre material.

The present invention makes it possible to provide a large number of reflectance curves calculated on the basis of previously optimised dye recipes. The number of reflectance curves and recipes is virtually unlimited since the corresponding data are produced arithmetically and not on the basis of dyeings. Thus, within a very short space of time and without dyeing costs, it is possible to provide as many reflectance curves as can be visually differentiated on the screen and as allow for manageable handling of the volume of data. The number of colours of a conventional colour catalogue can be exceeded in the manner according to the invention by a factor of from 10 to 20.

A further advantage is that the catalogue according to the invention can be produced flexibly without difficulty for requirements that have been defined in advance, which is not possible with conventional colour catalogues.

The following Examples serve to illustrate the invention without limiting the scope thereof.

### EXAMPLE 1

To dye polyamide according to the exhaust process, there are selected the acid dyes that, in the form of the free acid, correspond to the formulae given hereinafter

As yellow component, the dyes of formulae

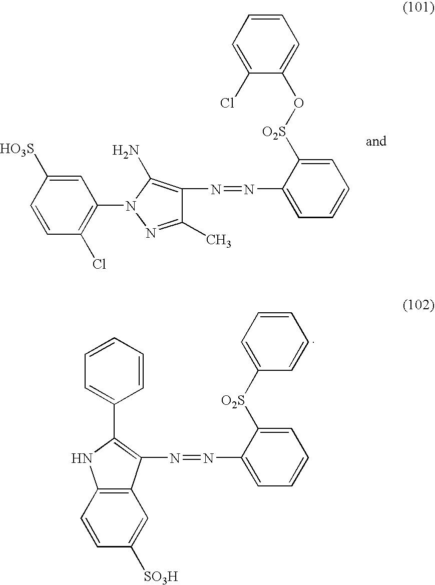

As red component, the dye of formula

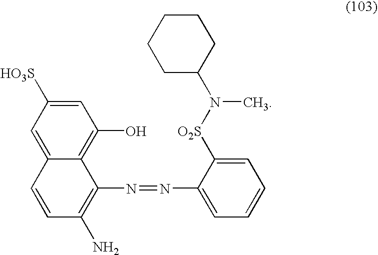

As blue component, a mixture of 25% by weight of the dye of formula

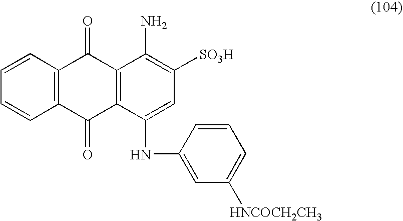

and 75% by weight of the dye of formula

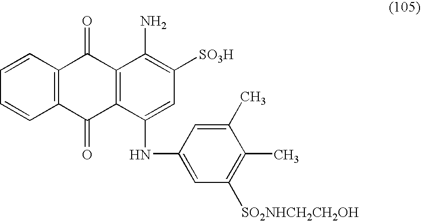

and the dye of formula

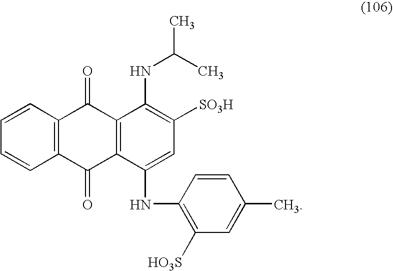

First the calibration data of the dyes are ascertained for the dyeing for which the colour catalogue is being produced. For that purpose, in each case a polyamide-6.6 fibre material (Helanka tricot) is dyed using the acid dyes specified above in different concentrations according to the exhaust process in a liquor ratio of 18:1. The dyeings are measured by spectral photometry and the CIE Lab colour coordinates are determined. The depths of shade for the individual dyeings are ascertained in known manner.

The depths of shade and the associated a* and b* data yield the colour position of the above-mentioned dyes in the FTa*b* colour space.

The colour space is then segmented within a depth of shade plane. Such segmentation is shown for a pale shade within a depth of shade plane in FIG. 1, where P1 corresponds to the colour position of the yellow dye of formula (101) for that dyeing; P2 corresponds to the colour position of the yellow dye of formula (102); P3 corresponds to the colour position of the red dye of formula (103); P4 corresponds to the colour position of the blue dye mixture of the dyes of formulae (104) and (105); and P5 corresponds to the colour position of the blue dye of formula (106).

For the trichromy consisting of the dyes of formulae (102), (103) and the dye mixture of the dyes of formulae (104) and (105), the triangular area in that depth of shade plane is divided arithmetically into a grid. The triangular area corresponds to the area having the comer points P2, P3 and P4. The gridded triangular area is shown in FIG. 3. Colour positions P2, P3 and P4 of the selected dyes in that depth of shade plane correspond to 0.13% by weight of the yellow dye of formula (102) for P2, 0.173% by weight of the red dye of formula (103) for P3 and 0.194% by weight of the blue dye mixture of the dyes of formulae (104) and (105) for P4.

The individual grid points on the connecting lines and within the triangular area correspond to specific concentration ratios between the dyes of formulae (102), (103), (104) and (105), that is to say to a specific dye recipe, from which the corresponding reflectance curves are calculated. The reflectance curves are stored in a data bank and formatted in such a manner that they can be imported into a commercially available colour communication system. The stored data are rendered visible as colours using a calibrated colour screen.

A user is looking for a pale violet shade which he can use to dye polyamide-6.6 fibre material. He decides upon the shade denoted by Px In FIG. 3, which he locates quickly on the screen. The dye recipe for the colour is recalculated by way of the corresponding reflectance curve and displayed. The recipe is as follows:
0.0247% by weight of the yellow dye of formula (102),
0.0739% by weight of the red dye of formula (103) and
0.0747% by weight of the blue dye mixture of the dyes of formulae (104) and (105).

The dye recipe calculated is used to dye polyamide-6.6 fibre material in accordance with the exhaust dyeing process in a liquor ratio of 18:1. The colour of the dyed fabric is identical in terms of shade, colour saturation and depth of shade to the shade from the catalogue that was determined arithmetically.

### EXAMPLE 2

To dye cotton in accordance with the exhaust process, there are selected the reactive dyes that, in the form of the free acid, correspond to the formulae given hereinbelow:

As yellow component, the dyes of formulae

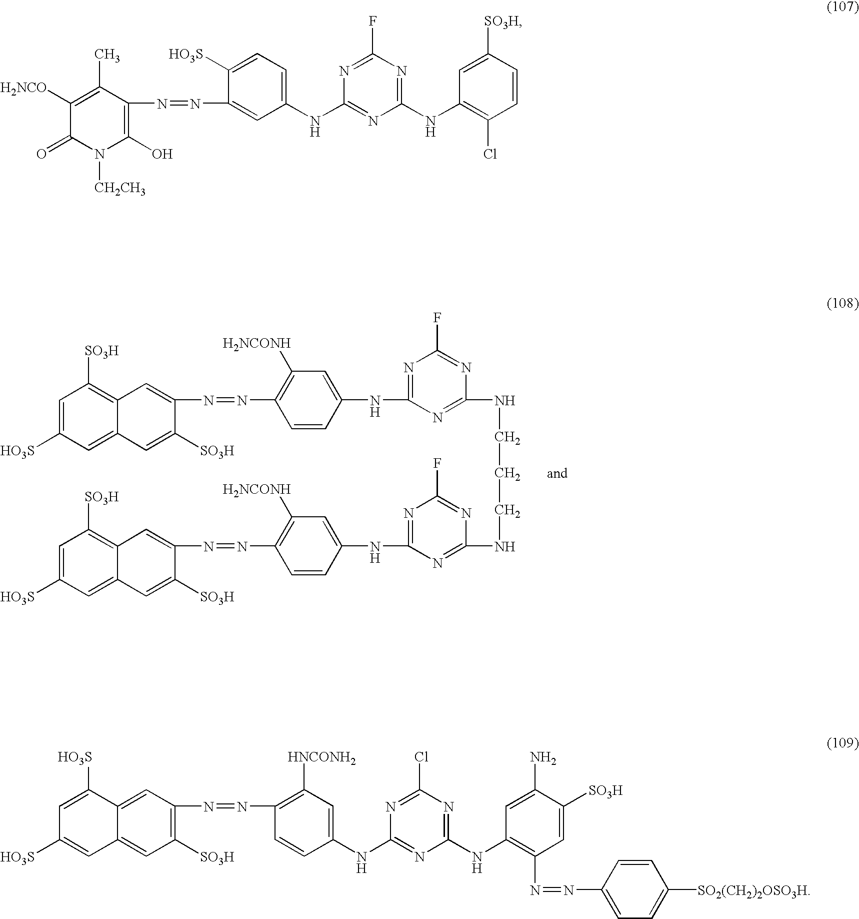

As orange component, a mixture of the dyes of formulae 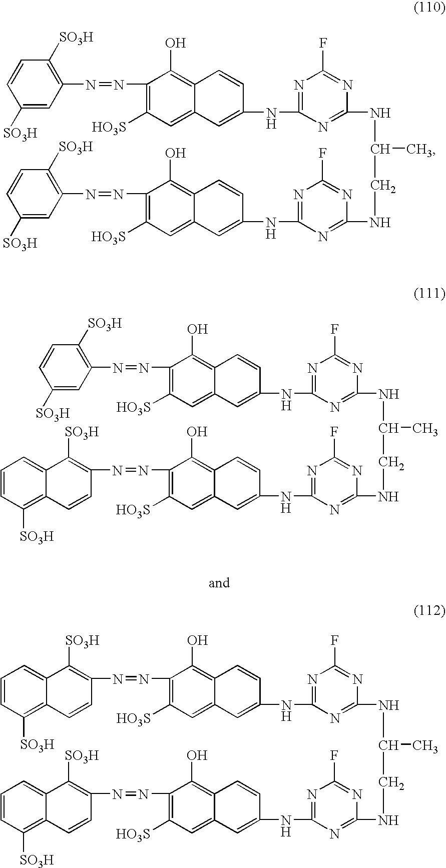
and a dye of formula

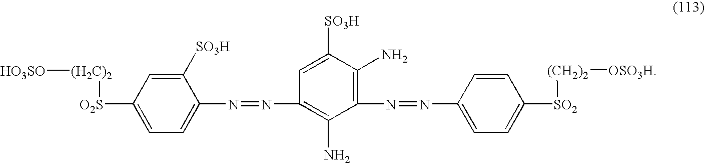

As red component, the dyes of formulae

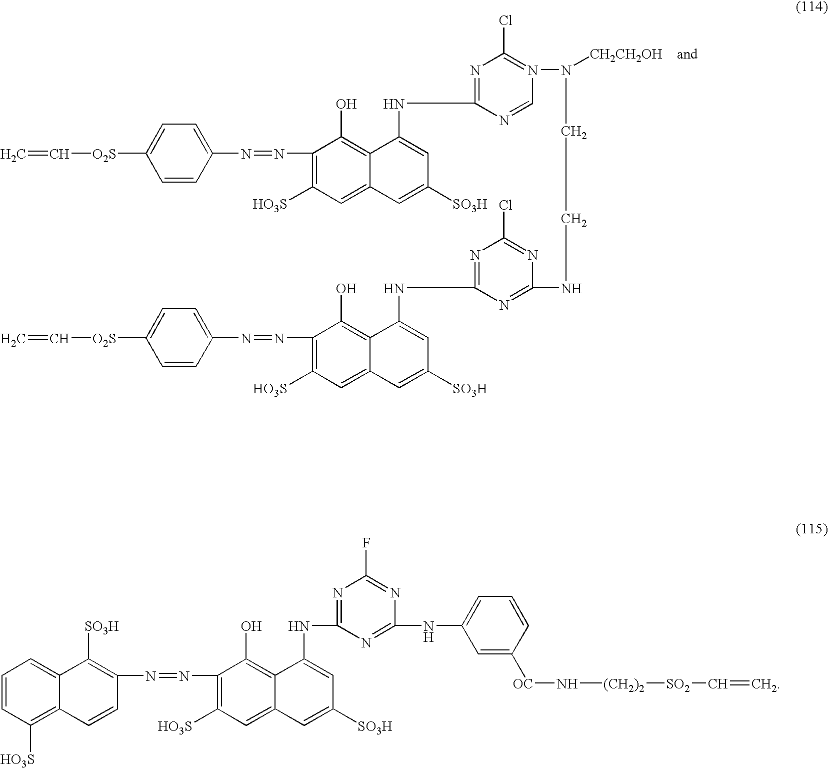

As blue component, the dyes of formulae 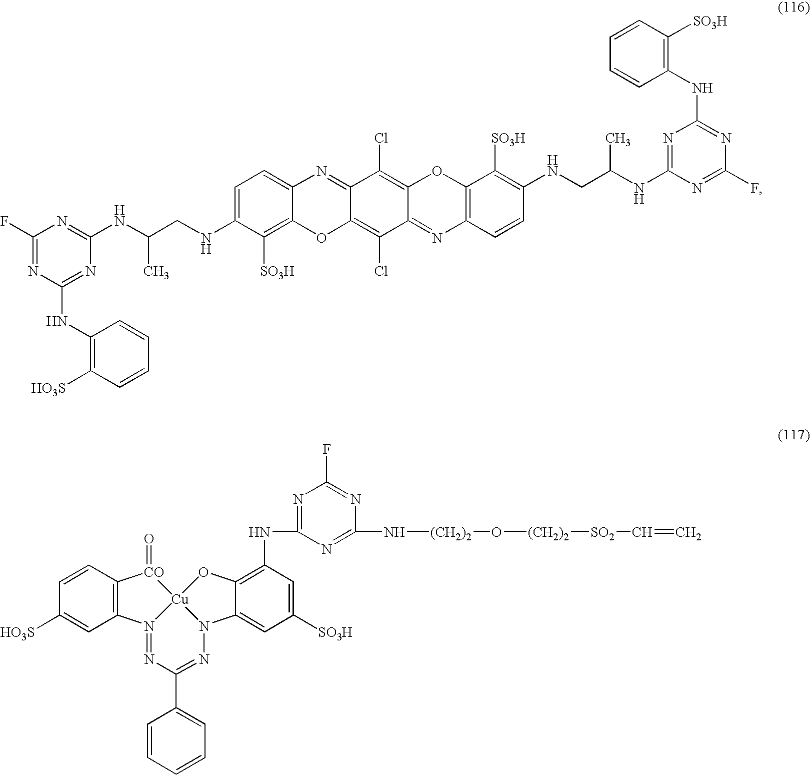
and a mixture of 32% by weight of the dye of formula (117) and 68% by weight of the dye of formula

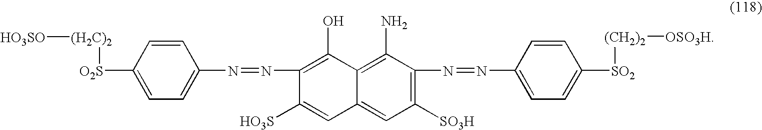

First the calibration data of the dyes are ascertained for the dyeing for which the colour catalogue is being produced. For that purpose, in each case cotton tricot is dyed using the reactive dyes specified above in different concentrations in accordance with the exhaust process at 60° C. in a liquor ratio of 10:1. The dyeings are measured by spectral photometry and the CIE Lab colour coordinates are determined. The depths of shade for the individual dyeings are ascertained in known manner.

The depths of shade and the associated a* and b* data yield the colour position of the dyes specified above in the FTa*b* colour space.

The colour space is then segmented within a depth of shade plane. Such segmentation is shown for a medium shade within a depth of shade plane in FIG. 2, where P1 corresponds to the colour position of the yellow dye of formula (107) for that dyeing; P2 corresponds to the colour position of the yellow dye of formula (109); P3 corresponds to the colour position of the orange dye mixture of the dyes of formulae (110), (111) and (112); P4 corresponds to the colour position of the orange dye of formula (113); P5 corresponds to the colour position of the red dye of formula (115); P6 corresponds to the colour position of the red dye of formula (114); P7 corresponds to the colour position of the blue dye of formula (116); P8 corresponds to the colour position of the blue dye of formula (117); and P9 corresponds to the colour position of the blue dye mixture of the dyes of formulae (117) and (118).

For a trichromy consisting of the dyes of formulae (108), (115) and (117), the triangular area in that depth of shade plane is divided arithmetically into a grid. The triangular area corresponds to the area having the comer points P10, P5 and P8. The colour position P10 for the yellow dye of formula (108) is not shown in FIG. 2. The gridded triangular area is shown in FIG. 4. The colour positions P10, P5 and P8 of the selected dyes in that depth of shade plane correspond to 1.51% by weight of the yellow dye of formula (108) for P10, 3.43% by weight of the red dye of formula (115) for P5 and 2.84% by weight of the blue dye of formula (117) for P8.

The individual grid points on the connecting lines and within the triangular area correspond to specific concentration ratios between the dyes of formulae (108), (115) and (117), that is to say to a specific dye recipe, from which the corresponding reflectance curves are calculated. The reflectance curves are stored in a data bank and formatted in such a manner that they can be imported into a commercially available colour communication system. The stored data are rendered visible as colours using a calibrated colour screen.

A user is looking for a dull orange shade which he can use to dye cotton tricot. He decides upon the shade denoted by Px in FIG. 4, which he locates quickly on the screen. The dye recipe for the colour is recalculated by way of the corresponding reflectance curve and displayed. The recipe is as follows:
1.17% by weight of the yellow dye of formula (108),
0.707% by weight of the red dye of formula (115) and
0.0465% by weight of the blue dye of formula (117).

The dye recipe calculated is used to dye cotton tricot in accordance with the exhaust dyeing process in a liquor ratio of 10:1. The colour of the dyed fabric is identical in terms of shade, colour saturation and depth of shade to the shade from the catalogue that was determined arithmetically.

### DESCRIPTION OF THE FIGURES

FIG. 1 is a diagram showing a depth of shade plane in the FTa*b* colour space, being segmented into 3 triangular areas, points P1 to P5 being comer points of the triangular areas.

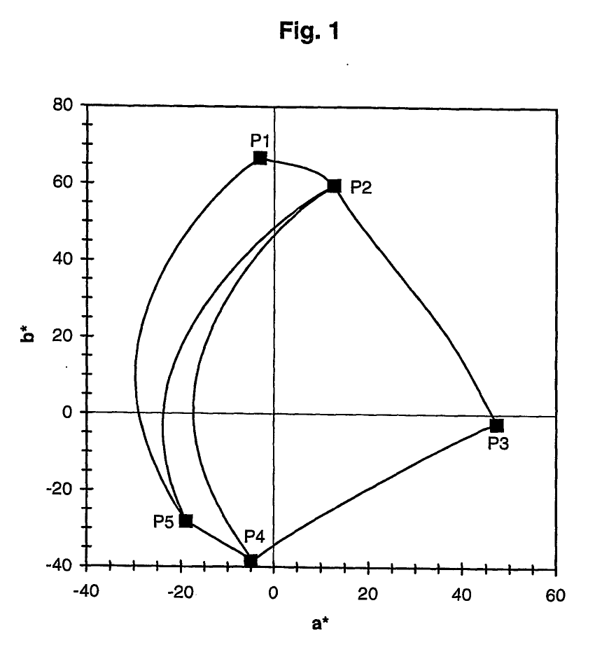

FIG. 2 is a diagram showing a depth of shade plane in the FTa*b* colour space, being segmented into 12 triangular areas, points P1 to P9 being the comer points of the triangular areas.

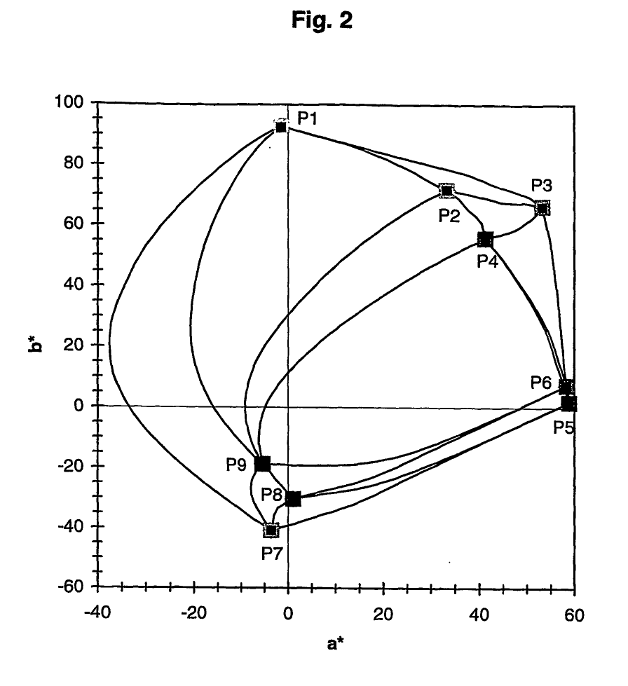

FIG. 3 shows the gridded segment having the comer points P2, P3 and P4 of FIG. 1.

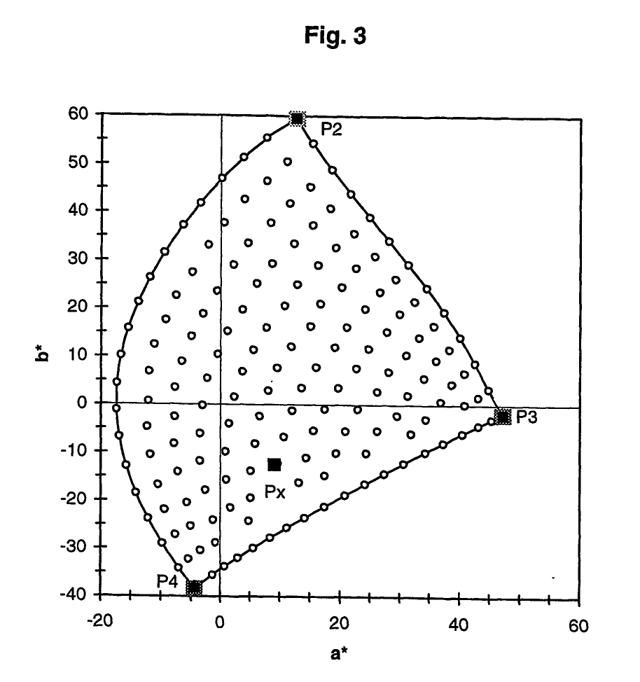

FIG. 4 shows the gridded segment having the comer points P10, P5 and P8, wherein P5 and P8 correspond to the corresponding data of FIG. 2.

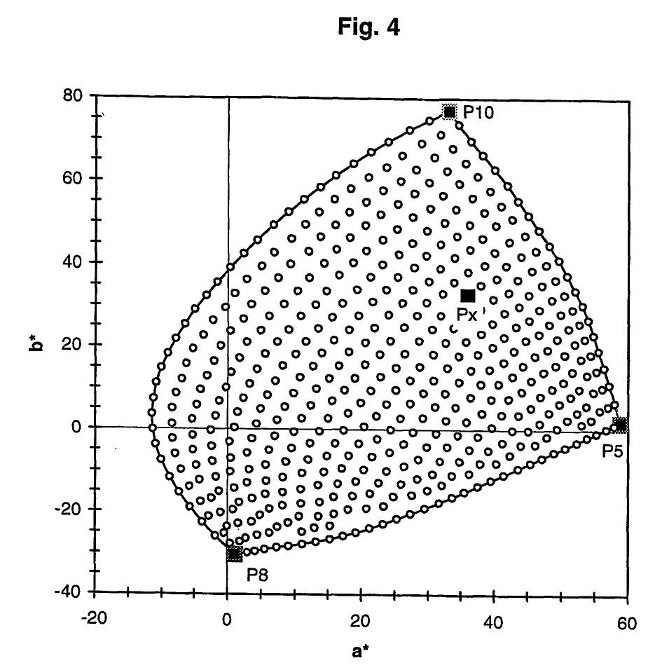

FIG. 5 shows the segment of FIG. 4 with a smaller number of grid points.

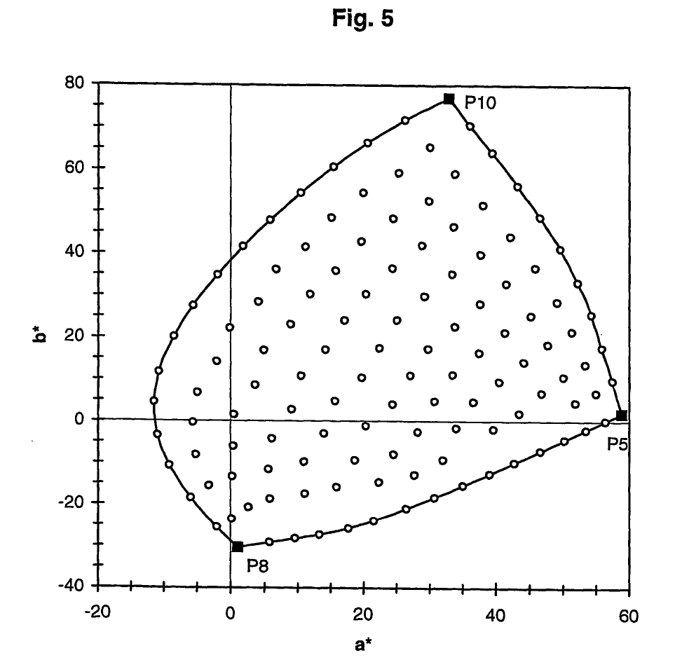

1. A method for the production of a digital colour catalogue, which comprises:
a) drawing up a requirement profile for the desired dyeing,
b) selecting a group of dyes that meet the requirement profile that has been drawn up,
c) determining within a colour space the colour position of dyes for the desired dyeing,
d) segmenting the colour space of the dyes within a depth of shade plane into triangular areas according to shade, wherein the corner points of the triangular areas correspond to the colour position of the dyes in question, and the said dyes define a range of shades delimited by the triangular areas,
e) dividing the triangular areas within a depth of shade plane arithmetically into a grid in such a manner that the points of intersection of the grid are distributed evenly over the triangular areas, where the points of intersection of the grid correspond to a colour position and a reflectance curve calculated on the basis of a dye recipe is associated with each of those colour positions, and
f) optionally visualising the reflectance curves associated with the colour positions by means of a suitable medium.

2. A method according to claim 1, wherein a computer is used to implement Steps c), d), e) and f).

3. A method according to claim 1, wherein a computer is used to store and manage the data obtained.

4. A method according to claim 1, wherein the FTa*b*. colour space is used as colour space.

5. A method according to claim 1, wherein the desired dyeing is a dyeing on leather or on a textile fibre material.

6. A method according to claim 1, wherein the dyes are disperse dyes, acid dyes, metal complex dyes, reactive dyes, vat dyes, sulfur dyes, direct dyes or pigments, or cationic dyes, natural dyes, developing dyes or food dyes.

7. A digital colour catalogue obtained according to the method of claim 1.

8. A method for the production of a dyeing on leather or on a textile fibre material, which comprises determining the amounts of dyes to employ from a digital colour catalogue according to claim 7.

9. A method according to claim 1, wherein the desired dyeing is a dyeing on a textile fibre material.
